(19) United States
(12) Patent Application Publication
(10) Pub. No.: US 2011/0197794 A1
(43) Pub. Date: Aug. 18, 2011

(54) Portable Device for Supplying Outlets Including Retractable Electrical Extension Cord

(76) Inventor: Vinicius José Gomes Nunes, Sao Paulo (BR)

(21) Appl. No.: 13/059,977

(22) PCT Filed: Mar. 16, 2009
(86) PCT No.: PCT/BR2009/000076

§ 371 Date: Feb. 19, 2011

(30) Foreign Application Priority Data
Oct. 29, 2008 (BR) MU8802424-5

(51) Int. Cl. H01R 13/46; A47B 37/00; A47B 21/00

(52) U.S. Cl. 108/50.02; 174/59

(57) ABSTRACT

“PORTABLE DEVICE FOR SUPPLYING OUTLETS INCLUDING RETRACTABLE ELECTRICAL EXTENSION CORD” consists in a body (1), on a pillar shape, with a wide base (2) in order to confer stability to the device. On the top of the body, there are outlets (6) disposed in appropriated height to supply devices positioned over an elevated surface such as a table, balcony or stand. The body contains electrical extension with mechanism of automatic retraction. Inside of the body there are two cylinders (8, 10) supported on two axes (9, 11), one in the base and another one next to the top. Both cylinders are involved by a strap (7) that contains two tracks (15) of conductive material in which are an electrical, flattened and thin cable (4) with an anti-stumbling effect. This cable (4) is rolled from one of its extremities on the strap (7), when retracted, and its opposing extremity leaves for an orifice (3) next to the base of the body, finishing in the electrical plug (5). The bottom cylinder (8) is tensioned by a spring (23) that makes the cable automatically retracts when the user desires to pick up the extension, driving the mechanism by pressing a button (2) installed on the body of the device. The top cylinder (10) has in its external surface two conductive tracks (24) that make contact with the conductive tracks (15) of the strap, whereas in the interior of the cylinder two brushes (25) of conductive material transmit the energy from the cable to the outlets supported in the top of the body, through conventional electric wires (12). The device enables several optional such as the inclusion of electrical circuit protection, electrical signal filter, DC adaptors, mobile phone chargers or cigarette lighter, in order to bring greater facility to the users, or to became more suitable for specific uses as, for example, computer equipment supplying.

The present utility model patent application relates to the sector of electrically-conductive connections. It describes a portable device for supplying outlets including a retractable and anti-stumbling electrical extension. It has a pillar shape and there are outlets on its upper part in order to supply electricity to equipment or home appliances over an elevated surface such as a table, balcony or stand, when a power supply is not near. The device may also include options like mobile phone chargers, DC adaptors, cigarette lighters and outlets for networking and telephony.

There are several electrical equipment that need to be used over an elevated surface like a table, balcony or stand. These devices include grills, toasters, rechauds, coffee makers, etc., which are usually used in residences and restaurants. Besides, there are informatics and telephony equipment, used in offices, stores and even residences that are also disposed in an elevated surface.

Sometimes there is no outlet near to these surfaces. A possible solution, to turn these electrical equipment on, could be the installation of a new outlet what demands time and is not always technically viable depending on the existing wiring.

The installation of a new outlet is fixed, then a new installation would be needed in an eventual change of position of the surface or devices. As well many of these devices are provisionally used. Thus, instead of having a new outlet installed on the place, a portable equipment that provides outlets and can be used in any situation is more appropriated. This device is the electrical extension cord of which several models are known.

When using conventional electrical extension cords some problems appears. The terminal of sockets stays over the floor, distant from the surface where the supplied device is. This makes cables to be exposed, force people to lower themselves in order to plug the devices and several times makes that terminal and cords remain hanging on the air to reach the height of the table. Another option would be leave the terminal of sockets over the table, what does not solve the problem of hanging cords offering the risk to people stumble, besides it takes unnecessary space.

Another problem observed in conventional electrical extension cords is that the cord itself, i.e., the wire, remains loose over the floor, allowing people to stumble on it and fall, or drag the equipment connected to the extension. An adhesive tape, or other kind of adhesive, is necessary to fix the wire of conventional extensions on the floor. This solution makes the floor dirty and makes difficult to remove the extension. It is also aesthetically unpleasant and several times does not solve the problem of people stumble.

In order to transport or keep the extensions it is necessary to store their wires. Frequently it is manually done and takes some time. The wire is not often stored inside the extension, remaining rolled up over its terminal, a reel or the wire itself, what is not functional. An automatic mechanism to retract and store the wire would be more appropriated.

Thus, it is easy to conclude that all electrical extensions already known have some problems: an inconvenient height for the terminal of sockets for supplying devices over an elevated surface; leave the wires loose offering risk of accidents and not be functional in the moment of pick up and store their wires.

The U.S. Pat. No. 2,110,036 presents a pedestal that tries to solve some of these problems elevating the terminal of sockets to the height of the surface. But it maintains its power cord loose offering risk to people stumble. This cord is manually rolled up and exposed stored. The U.S. Pat. No. 7,004,786 presents a cable organizer device with a pillar shape but with outlets disposed along of the body. The goal is to organize the wires from the several connected equipment hiding them in its interior. This cause a single input and output point to the power supply cords. The device is positioned near to a fixed electrical outlet and supplied by an extension cord. The loose wire problem allowing people to stumble persists. Its power cord is manually rolled up.

The U.S. Pat. No. 6,017,228 is characterized by being an electrical station and not an electrical extension. Being a complimentary device for an existing wiring connected to it through a power column, an extension or over a floor outlet. The station provides additional outlets, space and protection to organize the supply wires for different equipment. It has several doors to access the internal part. Besides not have the primary character of an extension, it does not solve the problems of the loose wire and wire storage. Although it is mobile it is not considered to being constantly changed of position. The extension shown in the U.S. Pat. No. 5,738,548 has its base direct connected to the electrical outlet and has an automatic wire retractable mechanism keeping it protected inside it. However the wire remains loose and hanging while the extension is being used, allowing people to stumble. There is not any kind of support for the terminal of sockets that goes up to the surface where the equipment to be supplied are.

To the effect to solve such problems it has been developed the PORTABLE DEVICE FOR SUPPLYING OUTLETS INCLUDING RETRACTABLE ELECTRICAL EXTENSION CORD, object of the present patent. It consists of a body on a pillar shape with a wide base which gives stability to the model. On the top of the body, there are a number of outlets arranged on appropriated height to supply devices on high surfaces as tables, balconies or stands. The body contains electrical extension with a mechanism of automatic retraction. Inside the body there are two cylinders supported on two axes, one in the base and the other one next to the top. The cylinders are involved for a strap that contains two tracks of conductive material. In this strap is connected an electrical, flattened and thin cable with an anti-stumbling effect. This cable is rolled up from one of its extremities over the strap, when retracted. Its opposite extremity leaves for an orifice next to the base of the body, finishing in the electrical plug that will be connected to the mains, from where will come the energy to supply the system. The cylinder below is tensioned by a spring that makes the cable automatically retracts when the user desires to pick up the extension. The user can drive the mechanism just pressing a button installed on the body of the device. The cylinder above has in its external surface two conductive tracks that make contact with the conductive tracks of the strap. In the interior of the cylinder two brushes of conductive material transmit the energy from the cable to the outlets supported on the top of the body by using conventional electrical wires.

In this manner, the PORTABLE DEVICE FOR SUPPLYING OUTLETS INCLUDING RETRACTABLE ELECTRICAL EXTENSION CORD solves the problems related with the outlets terminal localization. It also solves the problems of the inconvenience and the risk of the loose and elevated cable and that is not practical to pick up and to store the cable, remaining itself light and portable.

Beyond the presented functional advantages, the PORTABLE DEVICE FOR SUPPLYING OUTLETS INCLUDING RETRACTABLE ELECTRICAL EXTENSION CORD enables several optional such as the inclusion of electrical circuit protection, electrical signal filter, DC adaptors, mobile phone chargers or cigarette lighter, in order to bring greater facility to the users, or to became it more adequated for specific uses as, for example, computer equipment supplying.

Another constructive option is the use of the pillar as base of sustentation in a table, providing outlets in its surface or underneath its top.

### BRIEF DESCRIPTION OF THE DRAWINGS

The invention is described with reference to the following drawings in which:

FIG 1. Is a perspective view of the PORTABLE DEVICE FOR SUPPLYING OUTLETS INCLUDING RETRACTABLE ELECTRICAL EXTENSION CORD.

FIG. 2. Is a side view of the interior, showing the two cylinders, the electrical cable rolled and the set of outlets in the upper part.

FIG. 3. Is a perspective view of the electrical cable.

FIG. 4. Is a perspective view of part of the internal structure of the device, except the system of lock and drive of the automatic retraction mechanism.

FIG. 5. Is a perspective view of the system of lock and drive of the automatic retraction mechanism.

FIG. 6. Is a lateral view of the system of lock and drive of the automatic refraction mechanism in its locked position.

FIG. 7. Is a lateral view of the system of lock and drive of the automatic retraction mechanism in its unlocked position, i.e., drove the mechanism of automatic retraction.

FIG. 8. Is a perspective view of the cylinder below, with one section in its lateral surface in order to show the spring.

FIG. 9. Is an exploded perspective view of both axis and cylinder below, separated in order to detach the spring.

FIG. 10. Is a perspective view of the cylinder above, with one section in its upper lateral part in order to show the conductive brushes.

FIG. 11. Is an exploded perspective view of both axis and cylinder above, separated in order to detach the conductive brushes.

FIG. 12. Is a perspective view of the device incorporated on a table.

FIG. 13. Is a perspective view of the device incorporated on a table, with the outlets disposed below the top.

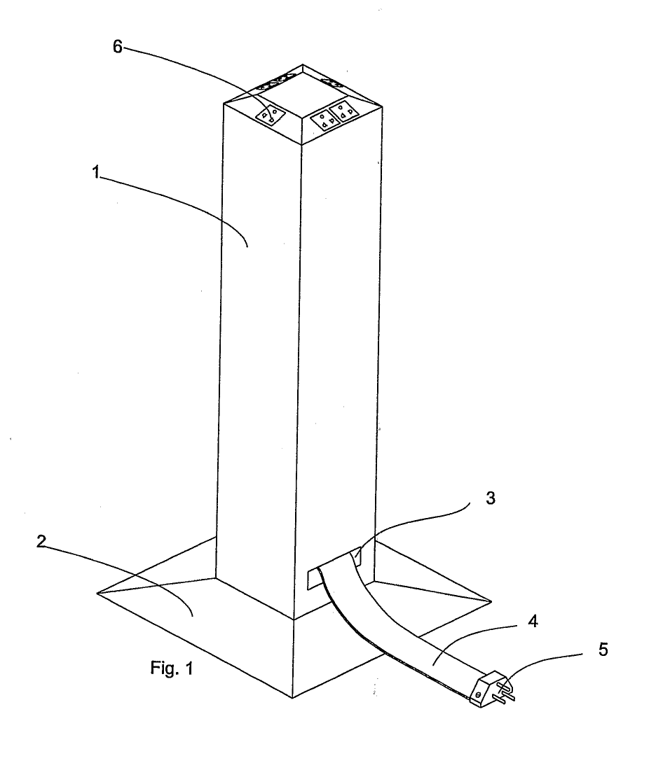

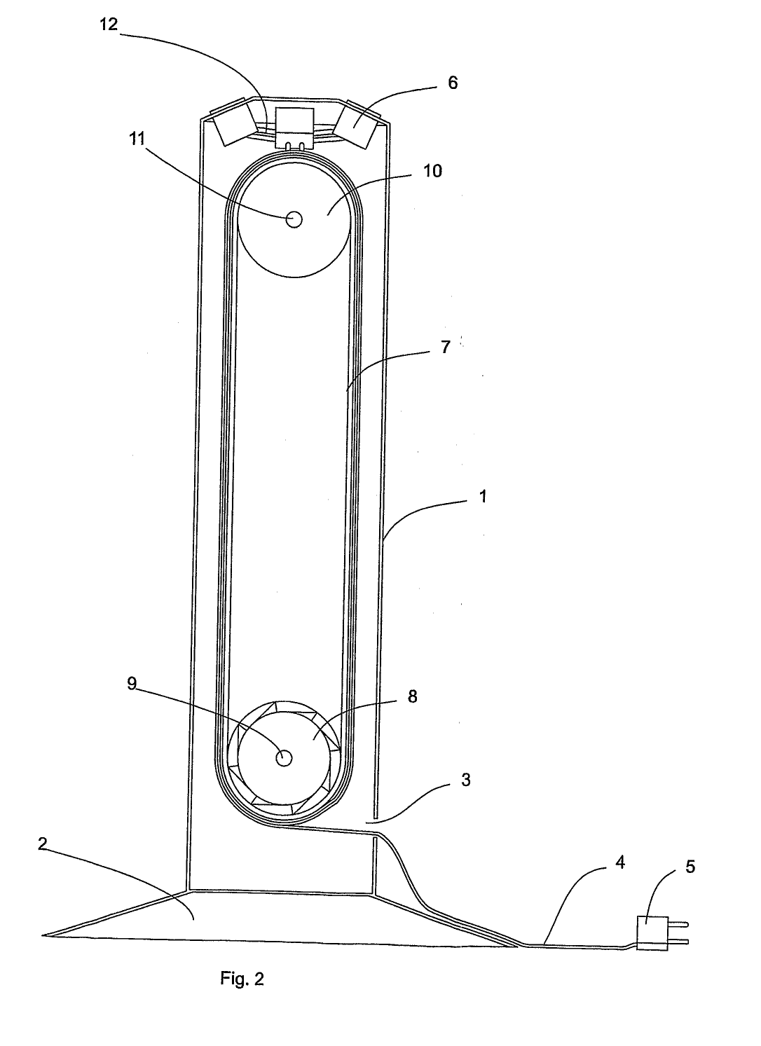

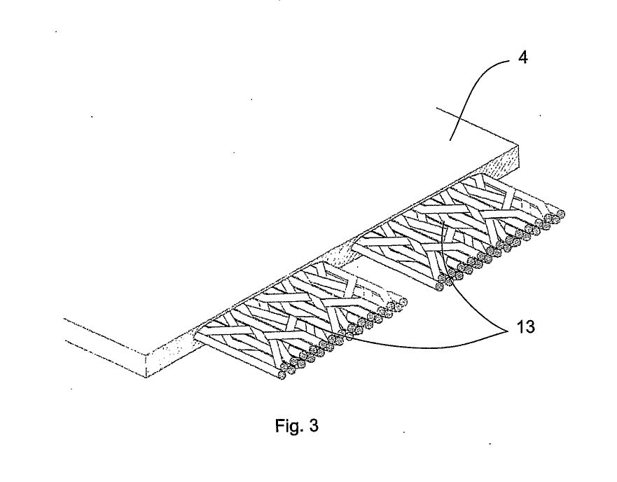

As the related figures, the PORTABLE DEVICE FOR SUPPLYING OUTLETS INCLUDING RETRACTABLE ELECTRICAL EXTENSION CORD have one body 1 on a pillar shape which offers a number of outlets 6 on its upper part. The body 1 is supported by a wide base 2, in order to give stability for the device. Both, the body and the base, are made with light materials such as aluminium, plastic or some other polymers. The body shelters a retractable automatic electrical extension, which flat cable 4 goes out by the body's orifice 3. In the external extremity of the cable it has a plug 5 for the connection of the extension to a mains outlet.

Inside body 1, there are two cylinders horizontally disposed, one in the bottom part 8 and another one on the top part 10, supported by axes 9 and 11, respectively. Cylinders and axes are constructed in plastic or polymeric material. Around these cylinders a strap 7 is rolled up, composing a rolling mat on which cable 4 is rolled.

The cable 4 is flat, fine and it is adjusted to the floor, getting an anti-stumbling effect. To guarantee the lowest possible cable profile, their conductive elements 13 are constructed in the form of a twister and flattened shield. The constructive details of the shield are described in our previous document BR MU8700403-8.

The internal structure of the device is shown in FIG. 4, where it can be noticed the strap 7 rolled up on cylinders 8 and 9. The strap is constructed in isolating material and re-covered by conductive tracks 15, on which conductive elements 13 of cable 4 are soldered, fixing the said cable to the strap and transmitting to the device the electrical energy coming from the mains through the cable. Wires 12 go from the axis 11 of the top cylinder 10 to the outlets 6, that will be externally available to the user of the device.

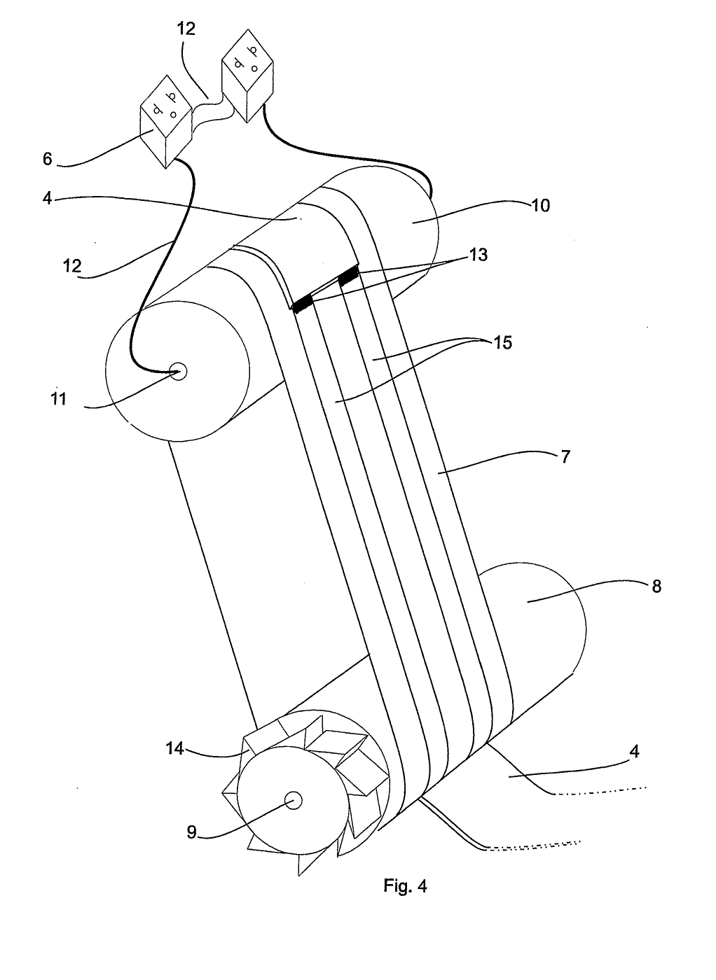

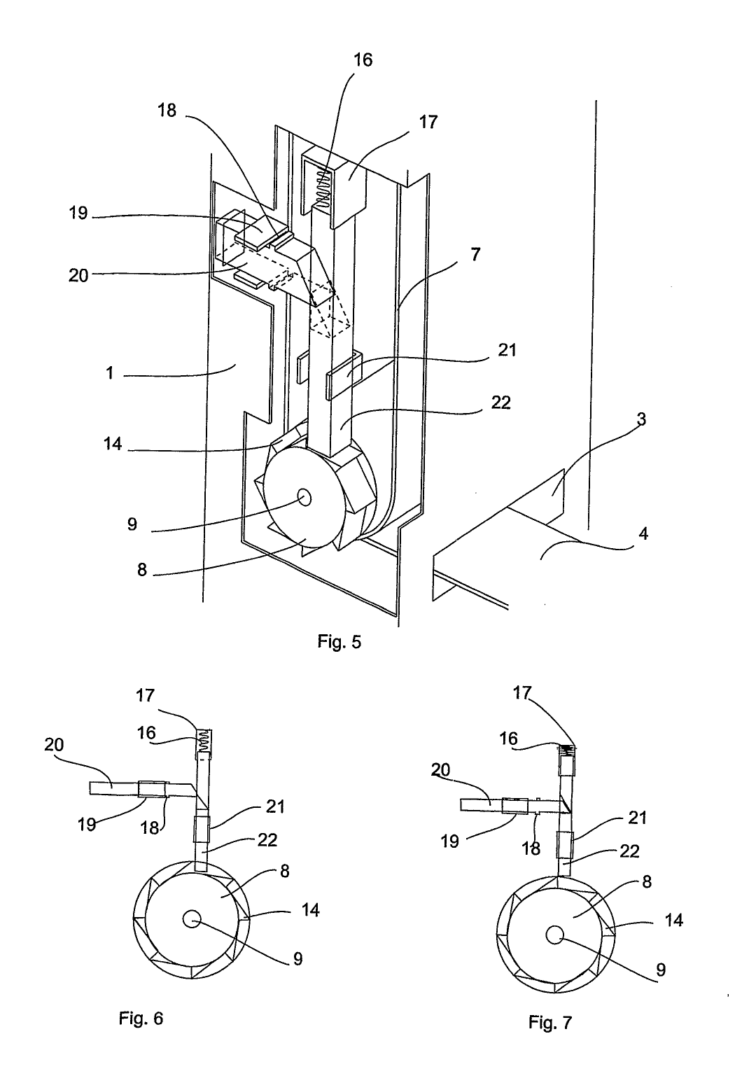

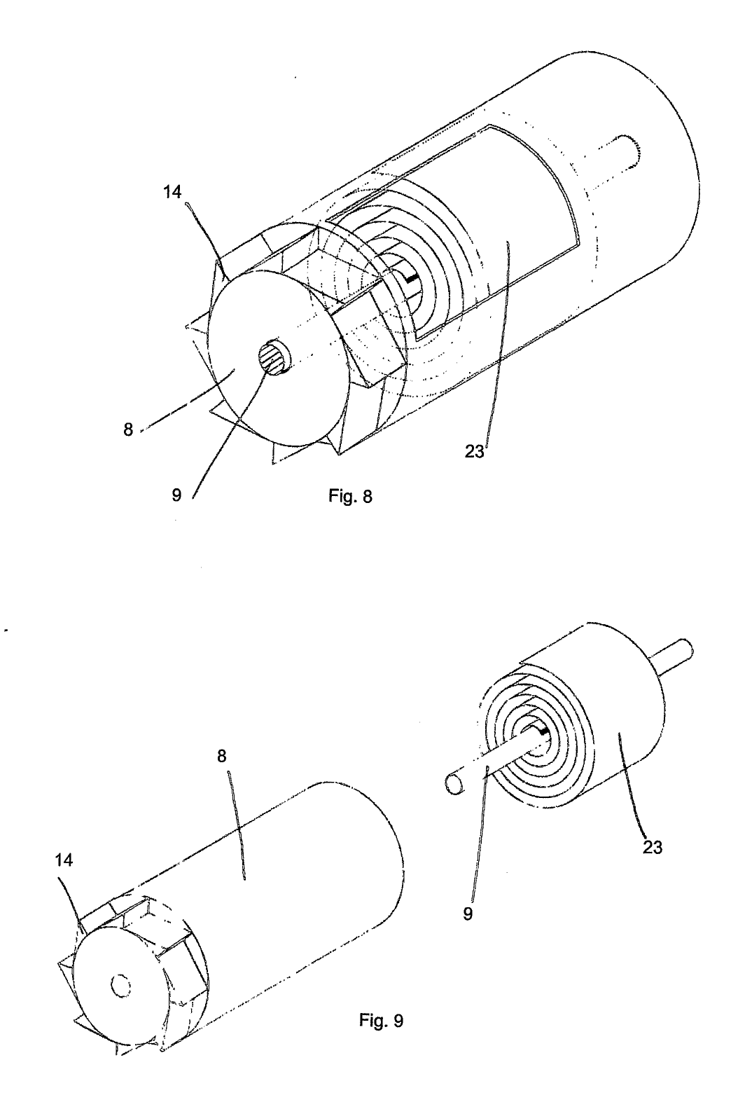

The automatic retraction mechanism is detailed in FIGS. 5 to 9. A rod 22, constructed in rigid material, acts as a lock when blocking the rotation of bottom cylinder 8 when supported on the blades 14 in its extremity. For this, the rod 22 is pushed by spring 16, that is installed in a rigid profile 17, through another rigid profile 21. The said profiles act as guides for rod 22. Such condition is detailed in FIG. 6. In FIG. 7 it is possible to see the mechanism in the unlocked condition that allows the cable retraction. To raise the rod 22, removing it of the lock position of bottom cylinder 8, button 20 is pressed. It is guided through Profile 19. The said button, whose extremity has a wedge form, fits perfectly in the indentation of same format in rod 22, pushing it to the top and compressing the spring 16. In this condition, the blades 14 used to brake bottom cylinder 8 are set free and the said cylinder is rotated by the force imposed for the spring tape 23, leashed to axis 9 of the said cylinder. Once this cylinder connects to the top cylinder 10 through strap 7, composing a mat, all the set moves, forcing the cable 4 that is rolled up on strap 7. When releasing button 20, spring 16 pushes rod 22 down and consequently button 20 returns to its original position, delimited for the lock 18 that is a salience in its structure, to limit the course of the button when meeting profile 19.

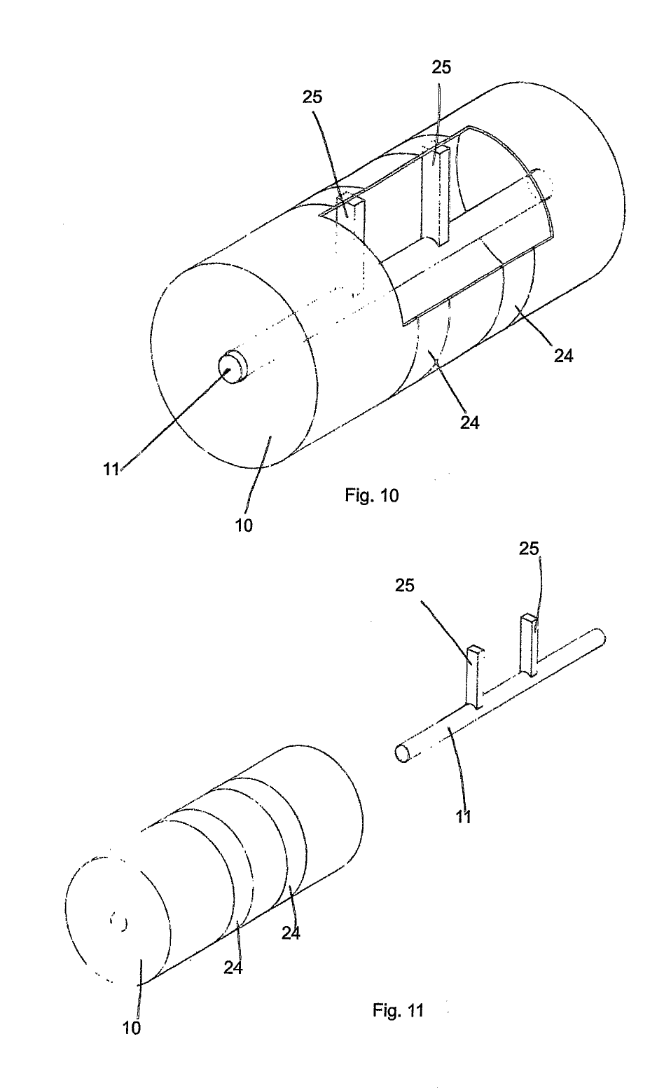

The top cylinder illustrated on the FIGS. 10 and 11 has two conductive tracks 24, which are constantly in touch with the conductive brushes 25 made with coal in this case. There are wires 12 connecting the brushes 25 to the outlets 6 passing through the inside of axis 11. Each wire connected to one extremity of the axis.

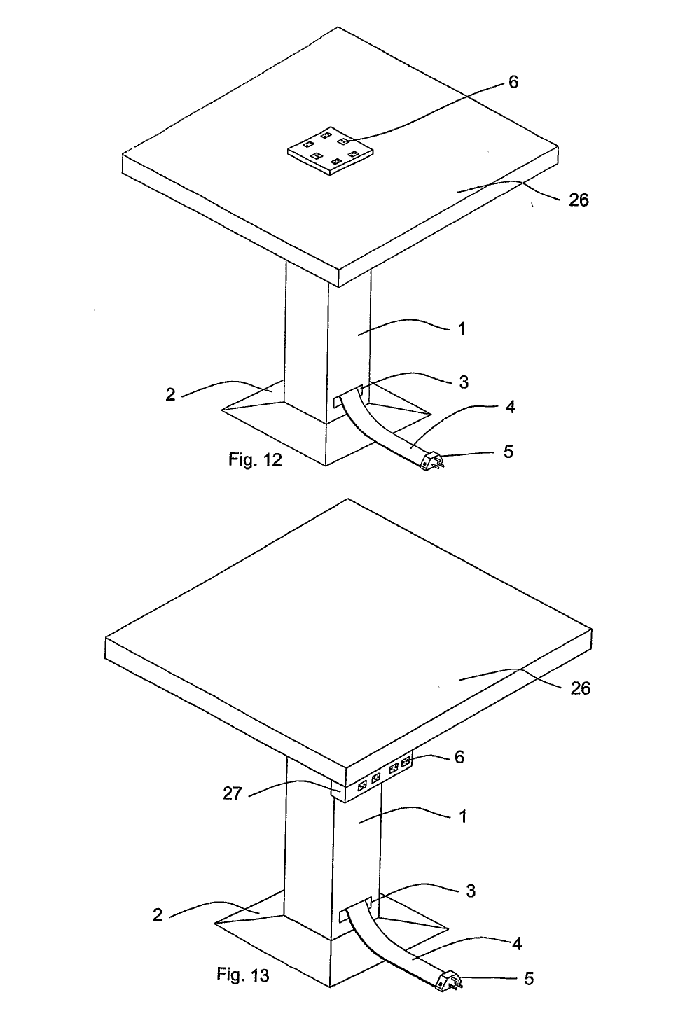

A possible variation of PORTABLE DEVICE FOR SUPPLYING OUTLETS INCLUDING RETRACTABLE ELECTRICAL EXTENSION CORD is its use as a sustentation pillar for a table, forming only one set. The outlets 6 can be disposed on the top 26 of the table, just as illustrated in FIG. 12, which is a good arrangement for using in offices. Another way is disposing the outlets underneath the top 26, in specific boxes 27. The boxes would be disposed in appropriated spot of the table in order not to disturb the people seated. This kind of disposal is appropriated to use in residence or restaurants.

Taking advantage of the additional space in body 1 or base 2, several optional equipment could be incorporated such as circuits of electrical protection, including fuse, light bulb pilot and on-off switch or breaker; electrical signal filter; universal DC adaptors; mobile phone chargers; cigarette lighter; electric insect eliminator; or battery and cell chargers.

Logically, the invention PORTABLE DEVICE FOR SUPPLYING OUTLETS INCLUDING RETRACTABLE ELECTRICAL EXTENSION CORD can be made in several sizes, capacities and configurations to supply the different needs of users.

1) “PORTABLE DEVICE FOR SUPPLYING OUTLETS INCLUDING RETRACTABLE ELECTRICAL EXTENSION CORD”.
understood for a body (1), on a Pillar shape, with a number of outlets (6) in its upper part, having a wide base (2), characterized for the said body to contain an electric extension with mechanism of automatic retraction, constituted of two cylinders (8, 10) supported on two axles (9, 11), that they are involved by a strap (7) that contains two tracks (15) of conductive material in which are an electrical, flattened and thin cable (4), with an anti-stumbling effect, that are rolled from one of its extremities on the strap (7), when retracted, and its opposing extremity leaves for an orifice (3) next to the base of the body, finishing in an electrical plug (5); The bottom cylinder (8) is tensioned by a spring (23) that makes the cable automatically retracts driving the mechanism by pressing a button (2) installed on the body of the device; the top cylinder (10) has in its external surface two conducting tracks (24) that make contact with the conductive tracks (15) of the strap, whereas in the interior of the cylinder two brushes (25) of conductive material transmit the energy of the cable to the outlets (6), through conventional electric wires (12); The device enables several optional such as the inclusion of electrical circuit protection, electrical signal filter, DC adaptors, mobile phone chargers or cigarette lighter, in order to bring greater facility to the users, or to became it more adequated for specific uses as, for example, computer equipment supplying.

1) “PORTABLE DEVICE FOR SUPPLYING OUTLETS INCLUDING RETRACTABLE ELECTRICAL EXTENSION CORD”, according with the first claim, it is used as a sustentation pillar for a table, forming only one set where the outlets are disposed on the top 26 of the table, or underneath the top 26, in specific boxes 27.
